(19) United States
(12) Patent Application Publication
(10) Pub. No.: US 2009/0249952 A1
(43) Pub. Date: Oct. 8, 2009

(54) Method and system for sorption of liquid or vapor phase trace contaminants from a fluid stream containing an electrically charged particulate

(75) Inventors: Kishor Purushottam Gadkaree, Big Flats, NY (US); Mark Peter Taylor, Montour Falls, NY (US)

Correspondence Address: CORNING INCORPORATED, SP-TI-3-1, CORNING, NY, 14831, US

(73) Assignee: CORNING INCORPORATED

(21) Appl. No.: 12/080,508

(22) Filed: Apr. 3, 2008

(51) Int. Cl. B03C 3/62

(52) U.S. Cl. 95/78; 96/66

(57) ABSTRACT

A method for the sorption of a liquid or vapor phase trace contaminant from a fluid stream containing an electrically charged particulate, which comprises:

providing a fluid stream comprising a liquid or vapor phase trace contaminant and an electrically charged particulate;

providing an electrically conductive stationary sorbent having an electrical charge that is of the same polarity as that of the charged particulate; and

contacting the fluid stream with the charged stationary sorbent, which sorbs the trace contaminant and repels the charged particulate.

### FIELD OF THE DISCLOSURE

This disclosure relates to a method and system for the sorption of a liquid or vapor phase trace contaminant from a fluid stream containing an electrically charged particulate.

### BACKGROUND

Hazardous contaminant emissions have become environmental issues of increasing concern because of the dangers posed to human health. For instance, coal-fired power plants and medical waste incineration are major sources of human activity related mercury emission into the atmosphere. Elemental mercury and its variants, such as methylmercury, are global pollutants.

It has been reported that human inhalation of elemental mercury has acute effects on kidneys and the central nervous system (CNS), such as mild transient proteinuria, acute renal failure, tremors, irritability, insomnia, memory loss, neuromuscular changes, headaches, slowed sensory-motor nerve function, and reduction in cognitive function. Acute inhalation of elemental mercury can affect gastrointestinal and respiratory systems, causing chest pains, dyspnea, cough, pulmonary function impairment, and interstitial pneumonitis. Studies also indicate that chronic exposure to elemental mercury can cause adverse effects on kidneys and the CNS, including erethism (increased excitability), irritability, excessive shyness, insomnia, severe salivation, gingivitis, tremors, and the development of proteinuria.

The main route of human exposure to methylmercury is the diet, such as by eating fish. Acute exposure to methylmercury can cause CNS effects such as blindness, deafness, and impaired level of consciousness. Chronic exposure to methylmercury results in symptoms such as paresthesia (a sensation of prickling on the skin), blurred vision, malaise, speech difficulties, and constriction of the visual field.

It is estimated that there are 48 tons of mercury emitted from coal-fired power plants in the United States annually. One DOE-Energy Information Administration annual energy outlook projected that coal consumption for electricity generation will increase from adjacent 976 million tons in 2002 to 1,477 million tons in 2025 as the utilization of coal-fired generation capacity increases. However, mercury emission control regulations have not been rigorously enforced for coal-fired power plants. A major reason is a lack of effective control technologies available at a reasonable cost, especially for elemental mercury control.

A technology currently in use for controlling elemental mercury as well as oxidized mercury is activated carbon injection (ACI). The ACI process involves injecting activated carbon powder into a flue gas stream and using a fabric fiber or electrostatic precipitator to collect the activated carbon powder that has sorbed mercury. ACI technologies generally require a high C:Hg ratio to achieve the desired mercury removal level (>90%), which results in a high portion cost for sorbent material. The high C:Hg ratio indicates that ACI does not utilize the mercury sorption capacity of carbon powder efficiently.

An activated carbon packed bed can reach high mercury removal levels with more effective utilization of sorbent material. However, a typical powder or pellet packed bed has a very high pressure drop, which significantly reduces energy efficiency. Further, these fixed beds are generally an interruptive technology because they require frequent replacement of the sorbent material depending on the sorption capacity.

Activated carbon honeycombs, such as those disclosed in US 2007/0261557, may also be utilized to achieve high removal levels of trace contaminants such as toxic metals. One complication that may be encountered in actual use of honeycombs in a power plant, however, relates to the presence of fly ash in the flue gas. Although systems have been developed for the removal of fly ash, these systems are about 99% efficient, meaning that some residual fly ash still evades capture in those systems.

Residual fly ash can deposit on activated carbon sorbents and may affect the mercury removal performance by, for instance, blinding oxidation catalysts or blocking high surface area pores on the sorbents. The deposition of residual fly ash on sorbents such as honeycombs may also increase pressure drop. Tests of activated carbon honeycombs in real flue gas have shown deposition of this residual fly ash on the leading edges of honeycomb monolith sorbents, and indeed show evidence of horizontal stalagmite buildups on the upstream side of the activated carbon honeycomb.

In industrial practice, methods such as the sonic horn or blowing air to remove ash are used for removal of fly ash in selective catalytic reduction systems. Such methods, however, are used after the fact to remove deposited fly ash, and do not prevent deposition of fly ash from occurring in the first place.

The inventors have discovered a method and system for reducing the deposition of fly ash on sorbents such as activated carbon honeycombs. The method and system utilize a sorbent capable of being electrically charged with the same charge as a particulate such as fly ash. The electrical charge to the sorbent repels the fly ash, thereby reducing or preventing deposition of the fly ash on the sorbent.

### BRIEF DESCRIPTION OF THE DRAWINGS

The invention can be understood from the following detailed description either alone or together with the accompanying drawings. The drawings are included to provide a further understanding of the invention, and are incorporated in and constitute a part of this specification. The drawings illustrate one or more embodiments of the invention and together with the description serve to explain the principles and operation of the invention.

FIG. 1 illustrates an example flow-through monolithic sorbent suitable for the practice of the invention.

FIG. 2 illustrates an example application of a honeycomb sorbent according to one embodiment of the invention.

### DESCRIPTION OF EMBODIMENTS OF THE INVENTION

One embodiment of the invention is a method for the sorption of a liquid or vapor phase trace contaminant from a fluid stream containing an electrically charged particulate, which comprises:

providing a fluid stream comprising a liquid or vapor phase trace contaminant and an electrically charged particulate;

providing an electrically conductive stationary sorbent having an electrical charge that is of the same polarity as that of the charged particulate; and

contacting the fluid stream with the charged stationary sorbent, which sorbs the trace contaminant and repels the charged particulate.

Another embodiment of the invention is a system comprising:

a charging device adapted to impart an electrical charge to particulates in a fluid stream;

an electrically conductive sorbent adapted to sorb a liquid or vapor phase trace contaminant; and

a conduit for providing passage of a fluid stream from the charging device to the electrically conductive sorbent.

The embodiments of the invention above can be used to reduce or prevent the occurrence of particulate deposition, such as fly ash deposition, on the sorbents. This allows the surface of the sorbent to remain clear for sorption of the liquid or gas phase trace contaminant. The invention may eliminate the need for mechanical techniques, such as sonic horns and air jets, to remove deposited particulates. Alternatively, the invention may at least allow for reducing the frequency of use of such mechanical techniques.

The invention may be used in the context of the sorption of any liquid or vapor phase trace contaminant from a fluid stream. The fluid stream may be in the form of a gas or a liquid. The gas or liquid may also contain another phase, such as droplets of liquid in a gas stream. Example gas streams include combustion flue gases (such as from bituminous and sub-bituminous coal types or lignite coal) and syngas streams produced in a coal gasification process.

The terms “sorb,” “sorption,” and “sorbed,” refer to the adsorption, absorption, or other entrapment of the trace contaminant on the sorbent, either physically, chemically, or both physically and chemically.

Trace contaminants to be sorbed include, for instance, contaminants at 3 wt % or less within the fluid stream, for example at 2 wt % or less, or 1 wt % or less. Trace contaminants may also include, for instance, contaminants at 10,000 μg/m³ or less within the fluid stream. Example trace contaminants include metals, including toxic metals. The term “metal” and any reference to a particular metal or other trace contaminant by name herein includes the elemental forms as well as oxidation states of the metal or other trace contaminant. Sorption of a metal thus includes sorption of the elemental form of the metal as well as sorption of any organic or inorganic compound or composition comprising the metal.

Example toxic metals include cadmium, mercury, chromium, lead, barium, beryllium, and chemical compounds or compositions comprising those elements. In one embodiment, the toxic metal is mercury in an elemental (Hg^{o}) or oxidized state (Hg⁺or Hg²⁺). Example forms of oxidized mercury include HgO and halogenated mercury, for example Hg₂Cl₂ and HgCl₂. Other exemplary metallic trace contaminants include nickel, cobalt, vanadium, zinc, copper, manganese, antimony, silver, and thallium, as well as organic or inorganic compounds or compositions comprising them. Additional trace contaminants include arsenic and selenium as elements and in any oxidation states, including any organic or inorganic compounds or compositions comprising arsenic or selenium. Volatile organic compounds (“VOCs”) are also exemplary trace contaminants.

The trace contaminant in the fluid stream may be in the gas phase or liquid phase. Thus, the trace contaminant may be present, for example, as a liquid in a gas fluid steam, or as a liquid in a liquid fluid stream. The trace contaminant could alternatively be present as a gas phase contaminant in a gas or liquid fluid stream. In one embodiment, the trace contaminant is mercury vapor in a coal combustion flue gas stream.

The electrically charged particulate may be of any composition capable of carrying an electrical charge. An example of a charged particulate is fly ash, for instance fly ash in a coal combustion flue gas. Particulates such as fly ash may comprise, for instance, amorphous or crystalline silicon dioxide, aluminum oxide, iron oxide, calcium oxide, and combinations and mixtures of these in any proportion. The particulates may be of any size suitable for the practice of the invention. For instance, the particulates may range from 0.5 μm to 100 μm in size, for instance 1 μm in size or less. The particulate may be of any shape, such as essentially spherical in shape.

The particulate may be provided with either a positive electrical charge or a negative electrical charge. As explained in greater detail below, the charge applied to the sorbent is of the same polarity as the charge of the particulate. In one embodiment, both the particulate and sorbent have a negative electrical charge.

The electrically charged particulate may be provided with its charge by any suitable method. For instance, the charge can be provided to the electrically charged particulate by passing a fluid stream comprising the particulate through a charging device, such as an electrostatic precipitator (“ESP”) upstream of the sorbent. An ESP applies a high voltage charge to particulates in the fluid stream and captures approximately 99% of the particulates on oppositely charged plates. The remaining fly ash exits the ESP with a negative charge. A negatively charged sorbent placed downstream of the ESP, such as an activated carbon honeycomb, will thereby repel the fly ash and reduce deposition of the fly ash on the sorbent surface.

Embodiments of the invention include contacting the fluid stream with a charged stationary sorbent, which sorbs the trace contaminant and repels the charged particulate. The terms “repel” and “repels” in the context of the sorbent interaction with the charged particulate refer to a reduction in the deposition of the particulate on the sorbent when compared to the deposition that would otherwise occur if the sorbent were not provided with the electrical charge. Thus, by repelling the charged particulate, the sorbent may entirely prevent deposition of the charged particulate or may reduce the extent of deposition of the charged particulate to any extent.

In some embodiments, the electrical charge density of the electrically conductive sorbent is of the same or greater magnitude as that of the charge density of the electrically charged particulate. This assists in the repulsion of the electrically charged particulate, particularly in instances where the flow of the fluid stream imparts the entrained particulate with significant momentum in the direction of the sorbent surface.

An electrical charge may be provided to the electrically conductive sorbent by any technique suitable for practice of the invention. For instance, the sorbent may be connected to a power source that supplies an electric charge to the sorbent. An electrical connection to the sorbent may be established with a power source using any electrically conductive material, such as a metallic material or metal wire. A metal wire may be wrapped around the sorbent or mechanically fastened to the sorbent by soldering, for instance. Exemplary materials for the electrical connection include copper and titanium wire.

In addition to the advantages of reduced deposition of particulates on the sorbents discussed above, embodiments of the invention may also improve sorption of the trace contaminant by an additional mechanism. In this regard, and in some embodiments, ions of the trace contaminant present in the fluid stream, such as ions of mercury, are expected to have a positive charge upon passage through an ESP. It is hypothesized that these positively charged ions will be attracted to a negatively charged sorbent, thus potentially improving the sorption efficiency of the sorbent. At the same time, the negatively charged sorbent will repel a negatively charged particulate. Embodiments of the invention are thus expected to not only prevent deterioration in performance related to particulate deposition, but also enhance the sorption efficiency.

Exemplary charged stationary sorbents include, for example, flow-through monolithic sorbents and planar sorbents. By “stationary,” it is meant that the sorbent is not itself a component entrained in the flow of the fluid stream, so it is stationary with respect to the direction of flow of the fluid.

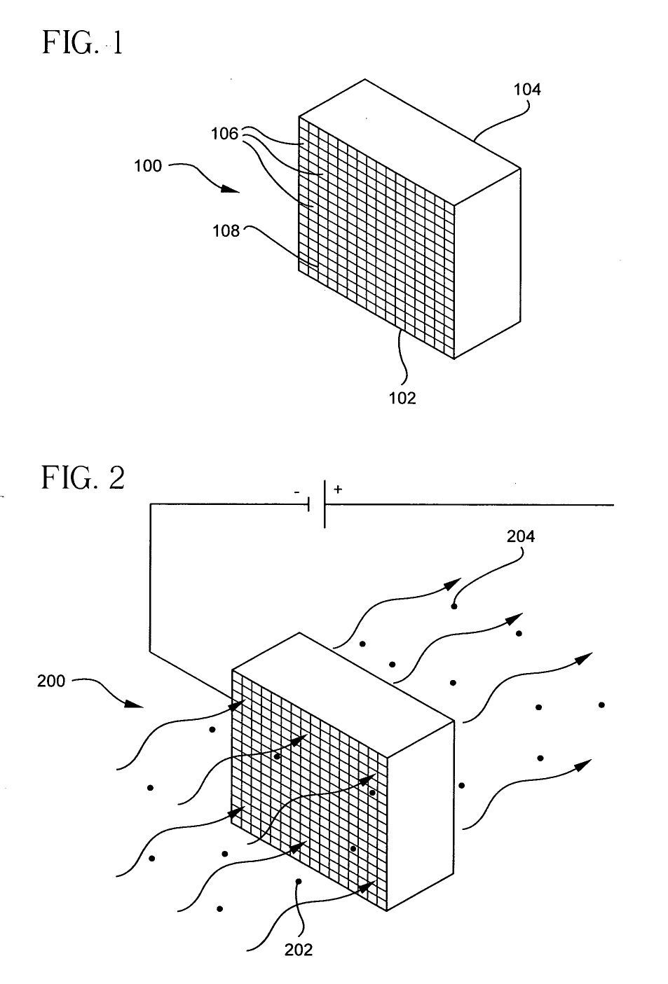

Exemplary planar sorbents include individual sheets of sorbent, or an array of sheets of sorbents that permit the flow of a fluid stream between parallel sheets rather than an in a flow-through configuration. Exemplary flow-through monolithic sorbents include, for example, any monolithic structure comprising channels or porous networks that would permit the flow of a fluid stream through the monolith. FIG. 1 illustrates one example embodiment of a flow-through monolithic sorbent suitable for the practice of the invention. The flow-through monolithic sorbent shown in FIG. 1 is a honeycomb sorbent 100 comprising an inlet end 102, an outlet end 104, and a multiplicity of cells 106 extending from the inlet end to the outlet end, the cells being defined by intersecting porous cell walls 108. The honeycomb sorbent could optionally comprise one or more selectively plugged honeycomb cell ends to provide a wall flow-through structure that allows for more intimate contact between the fluid stream and cell walls.

FIG. 2 illustrates an example application of a honeycomb sorbent according to one embodiment of the invention. In FIG. 2, a fluid stream comprising negatively charged particulates 202 flows through honeycomb 200. Honeycomb 200 is negatively charged, and repels the particulates, and the fluid stream exiting the honeycomb still contains the entrained electrically charged particulate 204.

The invention may be practiced using one sorbent, for example one flow-through monolithic sorbent, or two or more sorbents, for example, two or more flow-through monolithic sorbents, arranged in series or in parallel. One or more of such sorbents, and in some embodiments all of the sorbents, may be electrically conductive and may be provided with the same electrical charge. The invention includes the use of, for instance, at least 2, 3, 4, 5, 6, 7, 8, 9, 10, or more sorbents such as honeycomb sorbents arranged in series or in parallel.

Electrical connections may be provided among the sorbents to facilitate the application of a charge to the sorbents. Electrical connections among the electrically conductive sorbents may be established by any type of electrical contact between the sorbents, such as by providing electrical contact between two or more sorbents using a metallic material, such as a metallic wire or metallic sponge. Wires may be wrapped around the sorbents or mechanically fastened to the sorbents by soldering, for instance. Exemplary materials for the electrical connection include copper and titanium. Polymeric monofilaments may also be employed to provide electrical connections between sorbents.

The sorbents, such as flow-through monolithic sorbents, may be of any composition, structure, and dimensions suitable for the practice of the invention. The sorbents used in the context of the invention are electrically conductive. An electrically conductive sorbent includes a sorbent that has a continuous body that is electrically conductive. An electrically conductive sorbent also includes an electrically conductive or non-conductive body, such as a honeycomb, that is coated with an electrically conductive sorbent coating.

One or all of the sorbents may be in the form of honeycomb sorbents. One or all sorbents, such as flow-through monolithic sorbents, may comprise activated carbon. For example, one or all of the flow-through monolithic sorbents may have continuous activated carbon bodies, with or without additional materials included in the activated carbon matrix. In other embodiments, one or more sorbents comprise an electrically conductive coating that sorbs the trace contaminant. Such sorbents may be, for example, a glass, glass-ceramic, ceramic, or metal honeycomb coated with, for instance, activated carbon or other electrically conductive sorbent.

The electrically conductive sorbents, such as activated carbon-containing sorbents, may further comprise sulfur and/or a catalyst that catalyzes the sorption of the trace contaminant from the fluid stream. The sulfur and/or catalyst may be present in the batch mixture used to form the sorbents, or may be coated onto a sorbent that has already been formed, for example using a wash-coating technique. The term “sulfur” includes both elemental sulfur and sulfur in any oxidation state, including chemical compounds and compositions that comprise sulfur.

Any sorbents used according to the invention, whether positioned in series or parallel to one another, can be configured to be non-identical with respect to any one or more physical and/or chemical properties. For example, two or more adjacent or non-adjacent flow-through monolithic sorbents can comprise different monolithic structures, different compositions and, in the case of honeycombs for example, different cell densities, porous channel walls of differing thickness, or cell channels having differing sizes or cross-sectional geometries. Exemplary cell geometries for honeycomb sorbents can include circular, square, triangular, rectangular, hexagonal, sinusoidal, or any combination thereof. Adjacent or non-adjacent honeycombs may also be positioned such that the cells of the honeycombs are offset from one another. Such a configuration may promote a splitting of fluid streams from the cells of one honeycomb sorbent into two or more cells of another honeycomb sorbent in the series.

The sorbents may be positioned in any environment appropriate for the practice of the invention. For instance, sorbents may be positioned within a duct or any other enclosure carrying the fluid stream such as a combustion flue gas.

One or more other components that act on the fluid stream may be positioned within the flow of the fluid stream either upstream or downstream of the sorbents. For example, a charging device that is adapted to impart an electrical charge to particulates in a fluid stream may be placed upstream of the sorbent.

Embodiments of the invention thus include systems comprising a charging device adapted to impart an electrical charge to particulates in a fluid stream; an electrically conductive sorbent, such as a flow-through monolithic sorbent, adapted to sorb a liquid or vapor phase trace contaminant; and a conduit, such as a duct or any other type of enclosure, for providing passage of a fluid stream from the charging device to the electrically conductive sorbent.

An exemplary charging device is an ESP that, as discussed above, applies a high voltage charge to particulates in a fluid stream. Particulates such as fly ash then exit the ESP with a negative charge. Exemplary charging devices also include any electrodes, such as wires or planar electrodes, which can impart an electrical charge to particulates in the vicinity of the electrodes.

The system described above may comprise one or more sorbents, for instance one or more flow-through monolithic sorbents. As discussed earlier, electrical connections may be provided among the sorbents to facilitate the application of a charge to the sorbents.

Also as discussed earlier, the charge to the sorbents may be provided from any electrical power source. The electrical power connection to the sorbents may, for instance, be shared with the charging device. For instance, an electrical contact may be provided between one or more sorbents and the power source of an ESP. An example power source is a high voltage transformer.

It should be understood that while the invention has been described in detail with respect to certain illustrative embodiments thereof, it should not be considered limited to such, as numerous modifications are possible without departing from the broad spirit and scope of the invention as defined in the appended claims.

We claim:

1. A method for the sorption of a liquid or vapor phase trace contaminant from a fluid stream containing an electrically charged particulate, which comprises:
providing a fluid stream comprising a liquid or vapor phase trace contaminant and an electrically charged particulate;
providing an electrically conductive stationary sorbent having an electrical charge that is of the same polarity as that of the charged particulate; and
contacting the fluid stream with the charged stationary sorbent, which sorbs the trace contaminant and repels the charged particulate.

2. The method of claim 1, wherein the stationary sorbent is a flow-through monolithic sorbent, and wherein the fluid stream is contacted with the sorbent by passing the fluid stream through the flow-through sorbent.

3. The method of claim 2, wherein the flow-through monolithic sorbent is a honeycomb sorbent.

4. The method of claim 1, wherein the fluid stream is a coal combustion flue gas.

5. The method of claim 1, wherein the electrically charged particulate is fly ash.

6. The method of claim 1, wherein the trace contaminant is selected from cadmium, mercury, chromium, lead, barium, beryllium, arsenic and selenium, any of which are in an elemental or oxidized state.

7. The method of claim 6, wherein the trace contaminant is mercury in an elemental or oxidized state.

8. The method of claim 1, wherein the electrically charged particulate is fly ash and the trace contaminant is mercury in an elemental or oxidized state.

9. The method of claim 1, wherein the electrical charge of the electrically conductive sorbent is a negative electrical charge.

10. The method of claim 1, wherein the electrical charge density of the electrically conductive sorbent is of the same or greater magnitude as that of the charge density of the electrically charged particulate.

11. The method of claim 1, which comprises providing charge to the electrically charged particulate by passing a fluid stream comprising the particulate through an electrostatic precipitator.

12. The method of claim 1, wherein the electrically conductive sorbent comprises activated carbon.

13. The method of claim 1, wherein the electrically conductive sorbent comprises a glass, glass-ceramic, or ceramic coated with an electrically conductive coating.

14. The method of claim 13, wherein the electrically conductive coating comprises activated carbon.

15. A system comprising:
a charging device adapted to impart an electrical charge to particulates in a fluid stream;
an electrically conductive sorbent adapted to sorb a liquid or vapor phase trace contaminant; and
a conduit for providing passage of a fluid stream from the charging device to the electrically conductive sorbent.

16. The system of claim 15, wherein the charging device is an electrostatic precipitator.

17. The system of claim 15, wherein the electrically conductive sorbent is a flow-through monolithic sorbent.

18. The system of claim 15, wherein the electrically conductive sorbent is provided with electrical connections to one or more additional electrically conductive sorbents in the system.

19. The system of claim 15, which further comprises an electrical power source connected to the electrically conductive sorbent.

20. The system of claim 19, wherein the electrical power source connected to the electrically conductive sorbent is also connected to the charging device.
